(19) United States
(12) Patent Application Publication
(10) Pub. No.: US 2016/0023185 A1
(43) Pub. Date: Jan. 28, 2016

(54) ADSORBING MATERIAL

(71) Applicant: SONY CORPORATION, Tokyo (JP)

(72) Inventors: Seiichiro TABATA, Kanagawa (JP); Hironori IIDA, Kanagawa (JP); Shun YAMANOI, Kanagawa (JP); Shinichiro YAMADA, Kanagawa (JP)

(21) Appl. No.: 14/774,049

(22) PCT Filed: Mar. 3, 2014
(86) PCT No.: PCT/JP2014/001126

§ 371 Date: Sep. 9, 2015

(30) Foreign Application Priority Data
Mar. 15, 2013 (JP) 2013-053042

(51) Int. Cl. B01J 20/20; B01J 20/26; B01J 20/28; C01B 31/08

(52) U.S. Cl. CPC B01J 20/20; C01B 31/08; B01J 20/26; B01J 20/28011; B01J 20/28083; B01J 20/28071

(57) ABSTRACT

There is provided an adsorbing material for a filter for air purification, which is made of a porous carbon material derived from a plant and in which a value of particle porosity epsilonₚ is 0.7 or more.

### CROSS REFERENCE TO RELATED APPLICATIONS

This application claims the benefit of Japanese Priority Patent Application JP 2013-053042 filed Mar. 15, 2013, the entire contents of which are incorporated herein by reference.

### TECHNICAL FIELD

The present disclosure relates to an adsorbing material.

### BACKGROUND ART

Activated carbon using coconut husks or petroleum pitch as a raw material in the related art has been used as a material for various filters and has received attention as an adsorbent adsorbing, particularly, volatile organic compounds (VOCs). In addition, activated carbon has been used in order to remove unpleasant odors for improving comfort in rooms or automobiles.

### CITATION LIST

### Patent Literature

PTL 1: Japanese Unexamined Patent Application Publication No. 2008-104845

### SUMMARY

### Technical Problem

However, for example, according to Japanese Unexamined Patent Application Publication No. 2008-104845, activated carbon may not sufficiently adsorb a volatile organic compound. Further, a smell component as a source of an unpleasant odor is often attached to water vapor (water molecules) in the air. However, under the condition that the activated carbon may not efficiently adsorb water vapor and such a smell component is attached to water vapor (water molecules) in the air, it is difficult to remove the smell component with the activated carbon.

Accordingly, it is desirable to provide an adsorbing material that can adsorb various volatile organic compounds or water vapor with high efficiency.

### Solution to Problem

According to a first embodiment of the present disclosure, there is provided an adsorbing material for a filter for air purification, which is made of a porous carbon material derived from a plant and in which a value of particle porosity epsilonₚ is 0.7 or more. Further, in the adsorbing material according to the first embodiment of the present disclosure, it is preferable that particle apparent density rhoₚ be 0.5 g/mL or less. It is preferable that the particle porosity epsilonₚ be defined as follows.

Particle porosity epsilonₚ=alpha*beta*rhoₚ,

here,
rhoₚ is particle apparent density (unit: gram/milliliter) and calculated by 1/(1/rhoₜ+alpha*beta).
rhoₜ is particle true density (unit: gram/milliliter) and calculated by (sample mass/sample volume).
alpha is water content (g-water/g-wet) per wet weight.
beta is a conversion factor of dry weight (g-wet/g-dry).

According to a second embodiment of the present disclosure, there is provided an adsorbing material for a filter for air purification, which is made of a granular porous carbon material derived from a plant and in which a value of filling density rho_{b} is 0.2 g/mL or less. It is preferable that the filling density rho_{b} be calculated by obtaining a volume V₅₀₀ of 5.00 g of a dry porous carbon material having a particle diameter of 0.25 mm to 0.50 mm and by dividing the mass value of the dry porous carbon material by the volume V₅₀₀ thereof. It is preferable that an aspect ratio of the granular porous carbon material be 20 or less. The aspect ratio of the granular porous carbon material can be obtained based on a method for measuring an aspect ratio of 10 grains of an arbitrary particle by an SEM observation and setting the average value thereof as an aspect ratio.

According to a third embodiment of the present disclosure, there is provided an adsorbing material for a filter for air purification, which is made of a porous carbon material derived from a plant and in which a volume of a fine pore having a diameter of 20 nm or more is 1.0 mL/g or more based on a vapor adsorption method.

According to a fourth embodiment of the present disclosure, there is an adsorbing material for a filter for air purification, which is made of a porous carbon material derived from a plant and in which a volume of a fine pore having a diameter of 1 nm or more is 0.6 mL/g or more based on a methanol method described in “Industrial Chemistry Journal (Kogyo Kagaku Kaishi)” Vol. 73, No. 9, 1911 to 1915 (1970) or “Surface (Hyomen)” Vol. 13, pp. 588 to 592, pp. 650 to 656, and pp. 738 to 745 (1975).

According to a fifth embodiment of the present disclosure, there is provided an adsorbing material adsorbing acetone, which is made of a porous carbon material derived from a plant and in which an equilibrium adsorption amount of acetone in an air atmosphere containing 3 vol % of acetone is 0.29 mg/g or more.

According to a sixth embodiment of the present disclosure, there is provided an adsorbing material adsorbing toluene, which is made of a porous carbon material derived from a plant and in which an equilibrium adsorption amount of toluene in an air atmosphere containing 1.5 vol % of toluene is 0.5 mg/g or more.

According to a seventh embodiment of the present disclosure, there is provided an adsorbing material adsorbing water vapor, which is made of a porous carbon material derived from a plant and in which an equilibrium adsorption amount of water vapor in an air atmosphere having a temperature of 40 degrees Celsius and a relative humidity of 84% is 0.50 mg/g or more.

According to an eighth embodiment of the present disclosure, there is provided an adsorbing material adsorbing ammonia, which is made of a porous carbon material derived from a plant, in which when air containing 8 ppm of ammonia gas and having a temperature of 20 degrees Celsius and a relative humidity of 50% is ventilated with a space velocity of 5×10²/hour, and a removal rate of accumulated ammonia gas until one hour elapses from the start of ventilation is 0.3 micromol/g or more.

According to a ninth embodiment of the present disclosure, there is provided an adsorbing material adsorbing acetaldehyde, which is made of a porous carbon material derived from a plant, in which when air containing 0.14 ppm of acetaldehyde vapor and having a temperature of 20 degrees Celsius and a relative humidity of 50% is ventilated with a space velocity of 1.5×10⁴/hour, and a removal rate of accumulated acetaldehyde vapor until one hour elapses from the start of ventilation is 0.2 micromol/g or more.

According to another embodiment of the present disclosure, there is provided an adsorbing material comprising a porous carbon material derived from a raw material including a plant derived material, wherein the porous carbon material comprises a plurality of fine pores, and wherein the porous carbon material comprises at least one of a particle apparent density (rhoₚ) of 0.5 g/mL or less, and a particle porosity (epsilonₚ) of 0.7 or more.

According to a further embodiment of the present disclosure, there is provided a filter comprising an adsorbing material, the adsorbing material comprising a porous carbon material derived from a raw material including a plant derived material, wherein the porous carbon material comprises a plurality of fine pores, and wherein the porous carbon material comprises at least one of a particle apparent density (rhoₚ) of 0.5 g/mL or less, and a particle porosity (epsilonₚ) of 0.7 or more.

### Advantageous Effects of Invention

An adsorbing material according to a first to ninth embodiments of the present disclosure is made of a porous carbon material derived from a plant. Further, in an adsorbing material of the first embodiment of the present disclosure, the value of particle porosity epsilonₚ of the porous carbon material is defined. In an adsorbing material of the second embodiment of the present disclosure, the value of filling density rho_{b} is defined. In an adsorbing material according to the third embodiment of the present disclosure, the value of fine pore volume is defined based on a vapor adsorption method. In an adsorbing material according to the fourth embodiment of the present disclosure, the value of fine pore volume is defined based on a methanol method, and therefore it is possible to provide an adsorbing material which can effectively adsorb various volatile organic compounds or water vapor with high efficiency. In addition, in an adsorbing material according to the fifth embodiment of the present disclosure, the adsorbing material is specified by defining an equilibrium adsorption amount of acetone in a predetermined condition, and therefore it is possible to provide an adsorbing material which can effectively adsorb acetone with high efficiency. Further, in an adsorbing material according to the sixth embodiment of the present disclosure, the adsorbing material is specified by defining an equilibrium adsorbing amount of toluene in a predetermined condition, and therefore it is possible to provide an adsorbing material which can effectively adsorb toluene with high efficiency. Further, in an adsorbing material according to the seventh embodiment of the present disclosure, the adsorbing material is specified by defining an equilibrium adsorption amount of water vapor in a predetermined condition, and therefore it is possible to provide an adsorbing material which can effectively adsorb water vapor with high efficiency. Further, in an adsorbing material according to the eighth embodiment of the present disclosure, the adsorbing material is specified by defining a removal rate of accumulated ammonia gas in a predetermined condition, and therefore it is possible to provide an adsorbing material which can effectively adsorb ammonia with high efficiency. Furthermore, in an adsorbing material according to a ninth embodiment of the present disclosure, the adsorbing material is specified by defining a removal rate of accumulated acetaldehyde vapor in a predetermined condition, and therefore it is possible to provide an adsorbing material which can effectively adsorb acetaldehyde with high efficiency.

### BRIEF DESCRIPTION OF DRAWINGS

FIG. 1 is a schematic view illustrating a porous carbon material constituting an adsorbing material in Example 1.

FIG. 2 is a graph illustrating calculation results of an equilibrium adsorption amount of acetone of the adsorbing material in Example 1.

FIG. 3 is a graph illustrating calculation results of an equilibrium adsorption amount of toluene of an adsorbing material in Example 2.

FIG. 4 is a graph illustrating calculation results of an equilibrium adsorption amount of water vapor of an adsorbing material in Example 3.

FIG. 5 is a graph illustrating calculation results of a removal amount of accumulated ammonia gas of an adsorbing material in Example 4.

FIG. 6 is a graph illustrating calculation results of a removal amount of accumulated acetaldehyde vapor of an adsorbing material in Example 5.

### DESCRIPTION OF EMBODIMENTS

Hereinafter, the present disclosure will be described based on Examples with reference to the accompanying drawings, but the present disclosure is not limited thereto, and various numerical expressions and materials in Examples are merely examples. In addition, the present disclosure will be described in the following order.

1. Description concerning the overall adsorbing material according to a first embodiment to a ninth embodiment of the present disclosure

2. Example 1 (the adsorbing material according to the first embodiment to the fifth embodiment of the present disclosure)

3. Example 2 (the adsorbing material according to modification of Example 1 and the sixth embodiment of the present disclosure)

4. Example 3 (the adsorbing material according to modification of Example 1 and the seventh embodiment of the present disclosure)

5. Example 4 (the adsorbing material according to modification of Example 1 and the eighth embodiment of the present disclosure)

6. Example 5 (the adsorbing material according to modification of Example 1 and the ninth embodiment of the present disclosure) etc.

<Description Concerning the Overall Adsorbing Material According to a First Embodiment to a Ninth Embodiment of the Present Disclosure>

In the adsorbing material according to the first embodiment to the ninth embodiment of the present disclosure (hereinafter, also simply referred to as the “adsorbing material of the present disclosure” collectively), the porous carbon material uses a material derived from a plant as a raw material. Here, examples of the material derived from a plant may include chaff such as rice chaff, barley, wheat, rye, barnyard millet, or millet, straw, coffee beans, tea leaves (for example, leaves of green tea or tea), sugarcanes (more specifically, strained lees of sugarcanes), mealies (more specifically, the core of mealies), fruit skins (for example, skins of a citrus fruit such as skins of an orange, skins of a grapefruit, or skins of a mandarin orange or skins of banana), a reed, and a wakame seaweed stem. However, the material derived from a plant is not limited to these, other examples of the material may include tracheophytes growing on the ground, ferns, bryophytes, algae, and seaweeds. In addition, these materials can be used alone or plural kinds thereof can be used as a mixture, as a raw material. Further, the shape or the form of the material derived from a plant is not particularly limited, for example, chaff or straw may be used as is or a drying-processed product thereof may be used. Further, in the food or drink processing of beer, liquor, etc., ingredients subjected to various treatments such as a fermentation treatment, a roasting treatment, and an extraction treatment can be used as well. Particularly, it is preferable to use processed straw or chaff processed by threshing, etc., from the viewpoint promoting the recycling of industrial waste. This processed straw or chaff can be easily obtained in large amounts from, for example, agricultural cooperatives, companies producing alcoholic beverages, food companies, and food processing companies.

The adsorbing material of the present disclosure can be used for air purification, widely, for gas purification. The adsorbing material of the present disclosure can be made of a porous carbon material alone or a porous carbon material/polymer complex including a porous carbon material and a polymer. Here, examples of a binder constituting the porous carbon material/polymer complex may include carboxy nitrocellulose, a urea resin, a melamine resin, a phenol resin, an epoxy resin, a polyurethane-based resin, a resorcin-based resin, a vinyl acetate resin, a polyvinyl alcohol resin, a polyethylene resin, a polyester resin, a polystyrene resin, a poly(meth)acrylic resin, a poly(meth)acrylic acid ester resin, a (meth)acrylic acidstyrene copolymer resin, an ethylene-vinyl acetate copolymer resin, a vinyl acetate(meth) acrylic copolymer resin, and an ethylene-vinyl acetate-(meth)acrylic ternary copolymer resin, and among these, a butadiene-based resin or a styrene-based resin, which is hydrophilic and is barely hydrolyzed and swollen, such as an acrylonitrilebutadiene resin (AB resin), a styrene-butadiene resin (SB resin), an acrylonitrilebutadiene-styrene resin (ABS resin), an acrylic acid ester-styrene copolymer resin, or a methacrylic acid ester-styrene copolymer resin is more preferable. In addition, two or more binders thereof can be used together.

Further, a form of supporting (carrying) a porous carbon material or a porous carbon material/polymer complex (hereinafter, also referred to as “a porous carbon material and the like” collectively) by a supporting member can be exemplified. Examples of the supporting member may include woven fabric, non-woven fabric (including wet non-woven fabric), paper, and chemical fiber paper, and as a material constituting woven fabric, non-woven fabric, or chemical fiber paper, cellulose, polypropylene, polyester, or rayon can be exemplified. Examples of the supporting form may include a form in which a porous carbon material or the like is interposed between supporting members, a form in which a porous carbon material or the like is kneaded in a supporting member, a form in which a porous carbon material or the like infilters into a supporting member (for example, mixed paper), a form in which a porous carbon material is attached to a supporting member, and a form in which a supporting member is coated with a porous carbon material or the like.

Further, a use in powder, roughly pulverized, or granular shape, a use in sheet shape, a use in a state of shaping into a desired shape using a binder (binding agent) or the like, a use in a state of filling a column or a cartridge, or a use together with a corrugated honeycomb, pleated, or honeycomb supporting member can be exemplified.

In addition, the adsorbing material can constitute, for example, a filter of an air purification apparatus, a mask, protection gloves, protective shoes, or canister for a fuel tank of various automobiles.

Examples of the adsorbing object of the adsorbing material according to the first embodiment to the fourth embodiment of the present disclosure may include: a totally volatile organic compound (TVOC), specifically, a highly volatile organic compound (VVOC) such as propane, butane, or methyl chloride; a volatile organic compound (VOC) such as formaldehyde, acetaldehyde, d-limonene, triene, acetone, xylene, ethanol, 2-propane, hexanol, ethylbenzene, styrene, para-dichlorobenzene, tetradecane, chloropyrifos, phenol carp, phthalic acid di-n-butyl, phthalic acid di-2-ethylhexyl, or diazinon; a semi-volatile organic compound (SVOC) such as an insecticide (DDT, chlordane), a plasticizer (a phthalic acid compound), or a flame retardant; water vapor; and a smell component accompanied with water vapor. Further, a suspended granular substance, a particulate granular substance, an ultrafine particle, a fine particle of diesel exhaust, an inhalational particle, inhalational dust, falling dust, and an aerosol particle (suspended dust) can be also exemplified.

When a material derived from a plant containing silicon (Si) is used as a raw material of the porous carbon material in the adsorbing material of the present disclosure, specifically, but not limited thereto, it is preferable that the raw material of the porous carbon material be a material derived from a plant in which the content of silicon (Si) is 5% by mass or less, more preferably 3% by mass or less, and still more preferably 1% by mass or less.

The porous carbon material of the adsorbing material of the present disclosure can be obtained by carbonizing a material derived from a plant at a temperature range of 400 degrees Celsius to 1400 degrees Celsius and treating the material with acid or alkali. In a method for producing the porous carbon material of the adsorbing material of the present disclosure (hereinafter, also simply referred to as a “method for producing the porous carbon material”), the adsorbing material can be obtained by carbonizing a material derived from a plant at a temperature range of 400 degrees Celsius to 1400 degrees Celsius and the material prior to the treatment with acid or alkali is called “a porous carbon material precursor” or “a carbonaceous material.”

In the method for producing the porous carbon material, a process which carries out an activation treatment can be included subsequent to the treatment with acid or alkali or the treatment with an acid or alkali may be performed subsequent to the activation treatment. Further, the method for producing the porous carbon material including such a preferable form depends on the material derived from a plant being used, but the material derived from a plant can be subjected to a heat treatment (preliminary carbonization process) in a state of cutting off oxygen at a lower temperature than the temperature for carbonization (for example, 400 degrees Celsius to 700 degrees Celsius) prior to carbonization of the material derived from a plant. By doing this process, a tar component to be generated in the carbonization process can be extracted, and as a result, the tar component to be generated in the carbonization process can be reduced or removed. In addition, the state of cutting off oxygen can be achieved by preparing, for example, an inert gas atmosphere such as nitrogen gas or argon gas, or by preparing a vacuum atmosphere, or by putting the material derived from a plant in a kind of a baking state. In addition, the method for producing the porous carbon material depends on the material derived from a plant being used, but the material derived from a plant can be immersed in alcohol (for example, methyl alcohol, ethyl alcohol, or isopropyl alcohol) for reducing mineral components or moisture contained in the material derived from a plant and for preventing an unpleasant odor from being generated in the carbonization process. Further, the preliminary carbonization treatment may be carried out thereafter in the method for producing the porous carbon material. As a material for the heat treatment in an inert gas, for example, a plant largely generating pyroligneous acid (tar or light oil content) can be exemplified. Moreover, as a material preferable for a pretreatment using alcohol, seaweeds largely containing iodine or various minerals can be exemplified.

In the method for producing the porous carbon material, the material derived from a plant is carbonized at a temperature range of 400 degrees Celsius to 1400 degrees Celsius, here, carbonization means that an organic substance (a material derived from a plant in the porous carbon material of the adsorbing material of the present disclosure) is subjected a heat treatment to be converted to a carbonaceous material (for example, see JIS M0104-1984). In addition, as an atmosphere for carbonization, the atmosphere for cutting off oxygen may be exemplified, and specific examples thereof may include a vacuum atmosphere, an inert gas atmosphere such as nitrogen gas, or argon gas, and an atmosphere in which the material derived from a plant is in a kind of a baking state. The temperature raising rate up to the temperature for carbonization may be 1 degree/min or more, preferable 3 degree/min or more, and more preferably 5 degree/min or more in such an atmosphere, but not limited thereto. Further, the upper limit of the carbonization time may be 10 hours, preferably 7 hours, and more preferably 5 hours, but not limited thereto. The lower limit of the carbonization time may be the time that the material derived from a plant can be reliably carbonized. In addition, the material derived from a plant can be pulverized to be a desired particle size or classified as necessary. The material derived from plant can be washed in advance or the obtained porous carbon material precursor or the porous carbon material may be pulverized to be a desired particle size or classified as necessary. Alternatively, the porous carbon material after applying the activation treatment may be pulverized to be a desired particle size or classified as necessary. Furthermore, the finally obtained porous carbon material may be subjected to a germicidal treatment. The form, the configuration, or the structure of a furnace to be used for carbonization is not limited, and a continuous furnace or a batch furnace can be used.

In the method for producing the porous carbon material, as described above, it is possible to increase a microfine pore having a diameter smaller than 2 nm when an activation treatment is carried out. Examples of the activation treatment method may include a gas activation method and a chemical activation method. Here, the gas activation method is a method for using oxygen, water vapor, carbonic acid gas, or air as an activator and developing a microstructure using a volatile component or a carbon molecule in the porous carbon material by heating the porous carbon material at a temperature range of 700 degrees Celsius to 1400 degrees Celsius, preferably 700 degrees Celsius to 1000 degrees Celsius, and more preferably 800 degrees Celsius to 1000 degrees Celsius for several tens of minutes to several hours in the gas atmosphere. Further, more specifically, the heating temperature can be appropriately selected based on the kind of the material derived from a plant, the kind of gas, or the concentration thereof. The chemical activation method is a method for activating a material using zinc chloride, iron chloride, calcium phosphate, calcium hydroxide, magnesium carbonate, potassium carbonate, or sulfuric acid instead of oxygen or water vapor used in the gas activation method, washing with hydrochloric acid, adjusting pH with an alkaline aqueous solution, and then drying.

A chemical treatment or a molecular modification may be performed on the surface of the porous carbon material of the adsorbing material of the present disclosure. As a chemical treatment, a treatment of generating a carboxy group on the surface by applying a nitric acid treatment can be exemplified. In addition, it is possible to generate various functional groups such as a hydroxyl group, a carboxy group, a ketone group, and an ester group on the surface of the porous carbon material by applying the same treatment as the activation treatment using water vapor, oxygen, or alkali. Further, in the molecular modification, it is possible to chemically react the porous carbon material with chemical species or proteins having a hydroxyl group, a carboxy group, and an amino group which can be reacted with the porous carbon material.

In the method for producing the porous carbon material, a silicon component in the material derived from a plant subsequent to the carbonization is removed by applying a treatment with acid or alkali. Here, examples of the silicon component may include silicon oxides such as silicon dioxide, silicon oxide, and silicon oxide salts. By removing the silicon component in the material derived from a plant subsequent to the carbonization in this way, it is possible to obtain a porous carbon material having a high specific surface area. In some cases, the silicon component in the material derived from a plant subsequent to the carbonization may be removed based on a dry etching method.

The porous carbon material of the adsorbing material of the present disclosure may include nonmetallic elements such as magnesium (Mg), potassium (K), calcium (Ca), phosphrous (P), and sulfur (S), or metallic elements such as transition elements. The content of magnesium (Mg) may be in the range of from 0.01% by mass to 3% by mass, the content of potassium (K) may be in the range of from 0.01% by mass to 3% by mass, the content of calcium (Ca) may be in the range of from 0.05% by mass to 3% by mass, the content of phosphorous (P) may be in the range of from 0.01% by mass to 3% by mass, and the content of sulfur (S) may be in the range of from 0.01% by mass to 3% by mass. Further, it is preferable that the content of these elements be small from the viewpoint of increasing the value of a specific surface area. It is needless to say that the porous carbon material may contain elements other than the elements described above and the range of the content of various elements described above can be changed.

In the porous carbon material of the adsorbing material of the present disclosure, the analysis of the various elements can be performed by an energy dispersion X-ray spectrometry (EDS) using an energy dispersive X-ray analysis device (for example, JED2200F, manufactured by JEOL Ltd.). Here, the measurement condition may be set to a scanning voltage of 15 kV and an irradiation current of 10 microA.

The porous carbon material of the adsorbing material of the present disclosure has a large amount of fine pores. Examples of the fine pore include a “mesofine pore” having a pore diameter of 2 nm to 50 nm, a “macrofine pore” having a pore diameter of more than 50 nm, and a “microfine pore” having a pore diameter of less than 2 nm. Specifically, the porous carbon material has a large amount of fine pores having a pore diameter of 20 nm or less and, particularly, fine pores having a pore diameter of 10 nm or less as mesofine pores. In addition, fine pores having a pore diameter of about 1.9 nm, fine pores having a pore diameter of about 1.5 nm, and fine pores having a pore diameter of about 0.8 nm to 1 nm are largely included as microfine pores. In the porous carbon material of the adsorbing material of the present disclosure, it is desirable that the volume of a fine pore be 0.1 cm³/g or more, preferably 0.2 cm³/g or more, more preferably 0.3 cm³/g or more, and even more preferably 0.5 cm³/g or more based on a Barrett-Joyner-Halenda (BJH) method. Further, it is desirable that the volume of a fine pore be 0.1 cm³/g or more, preferably 0.2 cm³/g or more, more preferably 0.3 cm³/g or more, and even more preferably 0.5 cm³/g or more based on an MP method.

In the porous carbon material of the adsorbing material of the present disclosure, it is desirable that the value of the specific surface area (hereinafter, simply referred to as “the value of the specific surface area” in some cases) using a nitrogen BET method be preferably 50 m²/g or more, more preferably 100 m²/g or more, and even more preferably 400 m²/g or more, in order to obtain more excellent functionality.

The nitrogen BET method is a method for measuring an adsorption isotherm by allowing an adsorbent (here, the porous carbon material) to adsorb or desorb nitrogen as an adsorbing molecule and analyzing the measured data based on the BET formula represented by the formula (1), and it is possible to calculate the specific surface area or fine pore volume based on this method. Specifically, when the value of the specific surface area is calculated based on the nitrogen BET method, the adsorption isotherm is obtained by allowing the porous carbon material to first adsorb or desorb nitrogen as an adsorbing molecule. Further, an expression of [p/{Vₐ(p₀−p)}] is calculated based on the formula (1) or the formula (1′) which is modified from the formula (1) from the obtained adsorption isotherm and then plotted with respect to an equilibrium relative pressure (p/p₀). Subsequently, this plot is regarded as a straight line and a slant s (=[(C−1)/(C*Vₘ)]) and an intercept I (=[1/(C*Vₘ)]) are calculated based on a least squares method. Further, Vₘ and C are calculated from the obtained slant s and intercept I based on the formulae (2-1) and (2-2). Moreover, a specific surface area a _{sBET} is calculated from Vₘ based on the formula (3) (see BELSORP-mini and pp. 62 to 66 of BELSORP analysis software manual, manufactured by BEL Japan, Inc.). In addition, the nitrogen BET method is a measurement method in conformity with JIS R 1626-1996 “measuring methods for the specific surface area of fine ceramic powders by gas adsorption using the BET method.”

V₀=(Vₘ*C*p)/[(p₀−p){1+(C−1)(p/p₀)}] (1)

[p/{Vₐ(p₀−p)}]=[(C−1)/(C*Vₘ)](p/p₀)+[1/(C*Vₘ)] (1′)

Vₘ+1/(s+i) (2-1)

C=(s/i)+1 (2-2)

a_{sBET}=(Vₘ*L*sigma)/22414 (3)

Provided,

Vₐ: adsorption amount;

Vₘ: adsorption amount of monomolecular layer;

p: pressure when nitrogen is equilibrated;

p₀: saturated vapor pressure of nitrogen;

L: avogadro number; and

sigma: adsorption sectional area of nitrogen.

When a fine pore volume Vₚ is calculated using the nitrogen BET method, for example, adsorbed data of the obtained adsorption isotherm is linearly interpolated and an adsorption amount V is calculated with the relative pressure which is set by a fine pore volume calculation relative pressure. The fine pore volume Vₚ can be calculated from the adsorption amount V based on the formula (4) (see BELSORP-mini and pp. 62 to 65 of BELSORP analysis software manual, manufactured by BEL Japan, Inc.). In addition, hereinafter, the fine pore volume based on the nitrogen BET method is simply called as a “fine pore volume” in some cases.

Vₚ=(V/22414)×(M_{g}/p_{g}) (4)

Provided,

V: adsorption amount at the relative pressure;

M_{g}: molecular amount of nitrogen; and

P_{g}: density of nitrogen.

The pore diameter of a mesofine pore can be calculated in a form of distribution of fine pores using the rate of change in fine pore volume with respect to the pore diameter based on the BJH method. The BJH method is widely used as a method for analyzing fine pore distribution. When the fine pore is analyzed based on the BJH method, the adsorption isotherm is obtained by allowing the porous carbon material to adsorb or desorb nitrogen as an adsorbing molecule. Subsequently, the thickness of the adsorption layer when the adsorption molecule is gradually adsorbed or desorbed from the state in which the fine pores are filled with the adsorption molecules (for example, nitrogen) and the inner diameter (twice of the core radius) of the pore which is generated during the process are calculated based on the obtained adsorption isotherm, and the fine pore radius rₚ is calculated based on the formula (5), and then the fine pore volume is calculated based on the formula (6). In addition, a fine pore distribution curve is obtained by plotting the rate of change in fine pore volume (dVₚ/drₚ) with respect to the fine pore diameter (2rₚ) from the fine pore radius and fine pore volume (see BELSORP-mini and pp. 85 to 88 of BELSORP analysis software manual, manufactured by BEL Japan, Inc.).

rₚ=t+rₖ (5)

Vₚₙ=Rₙ*dVₙ−Rₙ*dtₙ*c*sigmaAₚⱼ (6)

provided,

Rₙ=rₚₙ²/(rₖₙ−1+dtₙ)² (7)

Here,

rₚ: fine pore radius;
rₖ: core radius (inner diameter/2) when an adsorption layer having a thickness t is adsorbed to the inner wall of the fine pore having fine pore radius rₚ due to the pressure;

Vₚₙ: fine pore volume when the n-th adsorption or desorption of nitrogen occurs;

dVₙ: amount of change at the time;

dtₙ: amount of change in thickness tₙ of the adsorption layer when the n-th adsorption or desorption of nitrogen occurs;

rₖₙ: core radius at the time;

c: fixed value; and

rₚₙ: fine pore radius when the n-th adsorption or desorption of nitrogen occurs. In addition, sigmaAₚⱼ represents an integrated value of the volume of a wall surface of a fine pore from j=1 to j=n−1.

The pore diameter of a microfine pore can be calculated in a form of distribution of fine pores using the rate of change in fine pore volume with respect to the pore diameter based on the MP method. When the fine pore distribution is analyzed based on the MP method, the adsorption isotherm is obtained by allowing the porous carbon material to adsorb nitrogen. Subsequently, the adsorption isotherm is converted to the fine pore volume with respect to the thickness t of the adsorption layer (t plotting), and then a fine pore distribution curve is obtained based on the curvature (amount of change in fine pore volume with respect to the amount of change in the thickness t of the adsorption layer) of the plot (see BELSORP-mini and pp. 72 and 73, pp. 82 of BELSORP analysis software manual, manufactured by BEL Japan, Inc.).

The porous carbon material precursor is treated with acid or alkali, but specific examples of the treatment method may include a method for immersing the porous carbon material precursor in an acid or alkali aqueous solution and a method for reacting the porous carbon material precursor with acid or alkali in vapor phase. More specifically, when the porous carbon material is treated with acid, as the acid, a fluorine compound which indicates acidity such as hydrogen fluoride, hydrofluoric acid, ammonium fluoride, calcium fluoride, or sodium fluoride can be used. When the fluorine compound is used, the amount of a fluorine element may be 4 times of a silicon element in a silicon component included in the porous carbon material precursor, and it is preferable that the concentration of an aqueous solution of a fluorine compound be 10% by mass or more. When a silicon component (for example, silicon dioxide) included in the porous carbon material precursor by hydrofluoric acid is removed, the silicon dioxide is reacted with the fluorine dioxide as shown in the chemical formula (A) or (B) and removed as hexafluorosilicic acid (H₂SiF₆) or silicon tetrafluoride (SiF₄), and the porous carbon material can be obtained. Subsequently, washing and drying can be performed.

SiO₂+6HF->H₂SiF₆+2H₂O (A)

SiO₂+4HF->SiF₄+2H₂O (B)

Further, the porous carbon material precursor is treated with alkali (base), and, for example, sodium hydroxide can be exemplified. When an alkali aqueous solution is used, the pH of the aqueous solution may be 11 or more. A silicon component (for example, silicon dioxide) included in the porous carbon material precursor is removed by an aqueous solution of sodium hydroxide, the silicon dioxide is reacted as shown in the chemical formula (C), removed as sodium silicate (Na₂SiO₃) by heating the aqueous solution of the sodium hydroxide, thereby obtaining the porous carbon material. In addition, when sodium hydroxide is treated by the reaction in vapor phase, the sodium hydroxide is reacted as shown in the chemical formula (C) by heating the solid thereof, and is removed as sodium silicate (Na₂SiO₃), thereby obtaining the porous carbon material. Subsequently, washing and drying can be performed.

SiO₂+2NaOH->Na₂SiO₃+H₂O (C)

Alternatively, as the porous carbon material of the adsorbing material in the present disclosure, for example, a porous carbon material (a so-called porous carbon material having a reverse opal structure) in which the holes disclosed in Japanese Unexamined Patent Application Publication No. 2010-106007 have a three dimensional regularity, specifically, a porous carbon material which includes three-dimensionally arranged spherical holes having an average diameter of 1×10⁻⁹ m to 1×10⁻⁵ m, and has a surface area of 3×10² m²/g or more, and preferably and macroscopically, a porous carbon material in which holes are arranged in an arrangement state corresponding to a crystalline structure or the holes are arranged macroscopically on the surface in an arrangement state corresponding to a face orientation of a face-centered cubic structure (111) can be used.

### Example 1

Example 1 relates to an adsorbing material according to the first to fourth embodiments of the present disclosure and an adsorbing material according to the fifth embodiment of the present disclosure. That is, the adsorbing material of Example 1 is an adsorbing material for a filter for air purification which is made of a porous carbon material derived from a plant and in which the value of particle porosity epsilonₚ is 0.7 or more. Further, the adsorbing material is an adsorbing material for a filter for air purification in which particle apparent density rhoₚ is 0.5 g/mL or less, or an adsorbing material for a filter for air purification in which a value of filling density rho_{b} is 0.2 g/mL or less, or an adsorbing material for a filter for air purification in which the volume of a fine pore having a diameter of 20 nm or more is 1.0 mL/g or more based on a vapor adsorption method, or an adsorbing material for a filter for air purification in which the volume of a fine pore having a diameter of 1 nm or more is 0.6 mL/g or more based on a methanol method described in the above-described literature. Furthermore, the adsorbing material of Example 1 is an adsorbing material adsorbing acetone, which is made of a porous carbon material derived from a plant, in which an equilibrium adsorption amount of acetone in an air atmosphere containing 3 vol % of acetone is 0.29 mg/g or more.

Here, as described above, the particle porosity epsilonₚ is defined as follows:

particle porosity epsilonₚ=alpha*beta*rhoₚ, and

rhoₚ is particle apparent density (unit: gram/milliliter) and calculated by 1/(1/rhoₜ+alpha*beta);

rho^{t} is particle true density (unit: gram/milliliter) and calculated by (sample mass/sample volume);

alpha is water content (g-water/g-wet) per wet weight; and

beta is a conversion factor of dry weight (g-wet/g-dry). Further, as described above, the filling density rho_{b} is calculated by obtaining the volume V₅₀₀ of 5.00 g of a dry porous carbon material having a particle diameter of 0.25 mm to 0.50 mm and by dividing the mass value of the dry porous carbon material by the volume V₅₀₀ thereof. It is preferable that the aspect ratio of the granular porous carbon material be 20 or less.

In Example 1 or Examples 2 to 5 described below, porous carbon materials derived from a plant described below were used. That is, as the material derived from a plant as a raw material of the porous carbon material, rice chaff was used. In addition, the porous carbon material carbonized the chaff as a raw material to be converted to a carbonaceous material (porous carbon material precursor), and then could be achieved by applying an acid treatment.

In the production of the adsorbing material, the material derived from a plant was carbonized at a temperature range of 400 degrees Celsius to 1400 degrees Celsius and then treated with acid or alkali, thereby obtaining a porous carbon material. In other words, first, a heat treatment (preliminary carbonization treatment) was carried out on the chaff in an inert gas. Specifically, the chaff was carbonized by heating at 500 degrees Celsius for 3 hours in a nitrogen gas stream, and then carbides were obtained. Further, it is possible to reduce or remove a tar component to be generated during the next carbonization by applying such a treatment. Subsequently, 10 g of the carbides were put into an alumina crucible, the temperature therein was raised up to 800 degrees Celsius with a temperature raising rate of 5 degree/min in a nitrogen gas stream (5 L/min), and carbonization was carried out at 800 degrees Celsius for 1 hour, and thereby, the resultant was converted to a carbonaceous material (porous carbon material precursor) to be cooled to room temperature. In addition, the nitrogen gas was allowed to continuously flow inside during the carbonization and the cooling process. Subsequently, the acid treatment was carried out by immersing the porous carbon material precursor in an aqueous solution of hydrofluoric acid of 46 vol/% for one night, and then the resultant was washed with water and ethyl alcohol until the pH thereof became 7. Next, the resultant was dried at 120 degrees Celsius, the temperature thereof was raised up to 900 degrees Celsius in a nitrogen gas stream, and a porous carbon material constituting an adsorbing material in Example 1 could be achieved by applying an activation treatment of heating the resultant at 900 degrees Celsius for 3 hours in a water vapor stream.

A commercially available coconut husk activated carbon (Comparative Examples 1A and 1B), a coal-based granular activated carbon (Comparative Example 1C), and a petroleum fibrous activated carbon (Comparative Example 1D) were used as Comparative Examples. Particle size distributions obtained by classifying the used sample material using a sieve (5 kinds of sieves with an aperture of 1.70 mm, 0.85 mm, 0.50 mm, 0.25 mm, and 0.106 mm) were listed in Table 1 below. In addition, the aspect ratio of the porous carbon material in Example 1 was about 10.

Comparative Example 1A: Kuraray coal GG, manufactured by KURARAY Co., Ltd.

Comparative Example 1B: Kuraray coal GW, manufactured by KURARAY Co., Ltd.

Comparative Example 1C: Calgon F400, manufactured by Calgon Carbon Japan KK.

Comparative Example 1D: Adole A-1, manufactured by Unitika Ltd.

(Table 1)

0.10 mm to 0.25 mm, 0.25 mm to 0.50 mm, 0.50 mm to 0.84 mm, 0.84 mm to 1.68 mm

Example 1 18.3 38.9 39.0 3.7

Comparative Example 1A 28.0 72.0 - -

Comparative Example 1B 21.0 79.0 - -

Comparative Example 1C 0.2 0.4 9.4 90.0

Further, the respective values of particle true density rhoₜ (unit: gram/milliliter), particle apparent density rhoₚ (unit: gram/milliliter), particle porosity epsilon_{b} (dimensionless), filling porosity epsilon_{b} (dimensionless), filling density rho_{b} (unit: gram/milliliter) of the used samples were listed in Table 2 below.

Here, the particle true density rhoₜ, the particle true density rhoₚ, and the particle porosity epsilonₚ were calculated with the method described below. In other words, pure water was added to the marked line of 25 milliliter of a measuring flask (mass: W₀) and a mass W3 was measured. Next, 2.0 g (W₂) of wet-sieved samples were added to the 25 milliliter of measuring flask, followed by adding about 15 milliliter of pure water thereto, and then a mass W₄ was measured by diluting with pure water after the deaeration. Here, in a case in which the density of pure water is set to 1.000 g/cm³, the volume of the measuring flask is W₃−W₀. On the other hand, the volume of the pure water is W₄−W₀−W₂. The particle true density rhoₜ is rhoₜ=W₂/volume of sample=W₂/(volume of measuring flask−volume of pure water). Accordingly, the particle true density rhoₜ can be obtained by the expression of rhoₜ=W₂/{(W₃−W₀)−(W₄−W0−W₂)}=W₂/(W₃+W₂−W₄). Further, the particle apparent density rhoₚ in which fine pores of a sample was included in a particle was calculated by the expression of rhoₚ=1/(1/rhoₜ+alpha*beta). In addition, the particle porosity epsilonₚ which is a fine pore volume rate of a sample can be calculated by the expression of epsilonₚ=vp*rhoₚ=alpha*beta*rhoₚ.

Moreover, the filling density rho_{b} and the filling porosity epsilon_{b} were calculated with the method described below. That is, the volume V₅₀₀ (unit: milliliter) of 5.00 g of a dried sample having a particle diameter of 0.25 mm to 0.50 mm was calculated. Further, the filling density rho_{b} of the sample was calculated by the expression of rho_{b}=5.0/V₅₀₀. Further, the filling porosity epsilon_{b} which is a volume rate other than the particles during the filling was calculated by the expression of epsilon_{b}=(1/rho_{b}−1/rhoₚ)/(1/rho_{b})=(1−rho_{b}/rhoₚ).

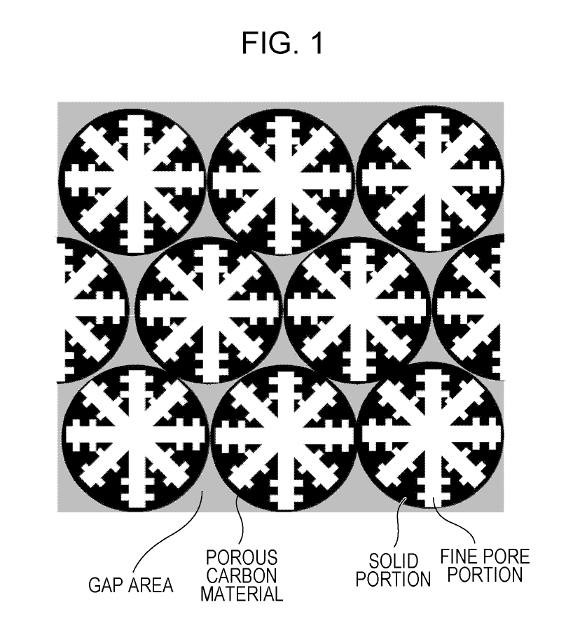

In addition, FIG. 1 is a schematic view illustrating a porous carbon material constituting an adsorbing material in Example 1. The circles in the figure schematically indicate the porour carbon material, the black parts inside of the circles in the figure schematically indicate the solid parts of the porous carbon material, the white parts inside of the circles in the figure schematically indicate the fine pore parts in the porous carbon material, the area between circles in the figure indicate the gap area (the gap area in an aggregate of the porous carbon materials) between the porous carbon materials. In addition, the particle true density rhoₜ, the particle apparent density rhoₚ, the particle porosity epsilonₚ, the filling density rho_{b}, and the filling porosity epsilon_{b} can be expressed as follows.

Particle true density rhoₜ: (mass of solid parts of porous carbon material)/(volume of solid parts of porous carbon material)

Particle apparent density rhoₚ: (mass of solid parts of porous carbon material)/(volume of solid parts of porous carbon material+volume of fine pore parts in porous carbon material)

Particle porosity epsilonₚ: (volume of fine pore parts of porous carbon material)/(volume of solid parts of porous carbon material+volume of fine pore parts in porous carbon material)

Filling porosity epsilon_{b}: (volume of gap area in porous carbon material aggregate)/(volume of porous carbon material aggregate)

Filling density rho_{b}: (volume of porous carbon material aggregate)/(volume of porous carbon material aggregate).

Moreover, a volume value (VL₁) of a fine pore having a diameter of 20 nm or more based on the vapor adsorption method, a volume value (VL′₁) of a fine pore having a diameter of less than 20 nm based on the vapor adsorption method, and a volume value (VL₂) of a fine pore having a diameter of 1 nm or more based on the methanol method described in the above literature are listed in Table 3 below.

Here, in the water vapor adsorption method, equilibrium adsorption amounts having a relative humidity of 84%, 64%, 50%, 40%, and 20% were calculated and the relation between the relative humidity and the equilibrium adsorption amount was illustrated.

The volume of fine pores was measured by the following procedures based on the methanol method. That is, the dried sample was added to a column with a stainless steel net having a volume of 5 mL and the mass thereof was measured. Next, each column was fixed to a gas adsorption device. In addition, gas having a relative pressure P/P₀ of 0.98 was ventilated to the gas adsorption device at about 1.0 L/min by adjusting methanol vapor flow rate and dry air flow rate to the columns. Subsequently, the gas was ventilated until the mass of columns became constant and then the methanol equilibrium adsorption amount in an air atmosphere containing methanol was calculated. Similarly, the methanol equilibrium adsorption amount in an air atmosphere containing methanol using gas having a relative pressure P/P₀ of 0.82, 0.60, 0.40, and 0.20 was calculated. Further, the equilibrium adsorption amount was calculated in terms of liquid volume by dividing with liquid density of 0.772 (gram/milliliter) at 40 degrees Celsius of methanol. Next, accumulated volume distribution, differential volume distribution, integrated specific surface area, and accumulated specific surface area of a fine pore were calculated from a methanol adsorption isotherm which is an approximate curve based on the plot of the methanol equilibrium adsorption amount of each relative pressure (P/P₀). Further, an inner surface area S of the porous material according to the methanol method was calculated by integrating deltaS=2deltaV/(rᵢ−rᵢ+1)/2 from a fine pore distribution and a volume change deltaV of fine pores of radius change deltar(rᵢ−rᵢ+1).

(Table 2)

rhoₜ rhoₚ epsilonₚ epsilon_{b} rho_{b}

Example 1 1.99 0.38 0.81 0.60 0.15

Comparative Example 1A 1.93 0.78 0.60 0.50 0.36

Comparative Example 1B 2.08 0.82 0.61 0.33 0.55

Comparative Example 1C 2.00 0.75 0.63 0.41 0.44

Comparative Example 1D 2.02 0.74 0.64 0.80 0.15

(Table 3)

VL₁ VL′₁ VL₂

Example 1 1.31 0.79 0.79

Comparative Example 1A 0.39 0.40 0.40

Comparative Example 1B 0.37 0.38 0.38

Comparative Example 1C 0.30 0.54 0.53

Comparative Example 1D 0.43 0.43 0.42

It is understood that the value of the particle apparent density rhoₚ of the porous carbon material in Example 1 is smaller than those of Comparative Examples 1A to 1D and the value of the particle porosity epsilonₚ is higher than those of Comparative Examples 1A to 1D as listed in Table 2. Further, it is understood that the value of the filling density rho_{b} of the granular porous carbon material in Example 1 is smaller than those of Comparative Examples 1A to 1C which describe granular samples.

It is understood that the volume value (VL₁) of a fine pore having a diameter of 20 nm or more based on the water vapor adsorption method in Example 1 is equal to or more than 0.8 cm³/g compared to Comparative Examples 1A to 1D as listed in Table 3. Further, it is understood that the volume value (VL′₁) of a fine pore having a diameter of less than 20 nm based on the water vapor adsorption method in Example 1 is equal to or more than 0.2 cm³/g compared to Comparative Examples 1A to 1D. Furthermore, it is understood that the volume value (VL₂) of a fine pore based on the methanol method in Example 1 is equal to or more than 0.2 cm³/g compared to Comparative Examples 1A to 1D.

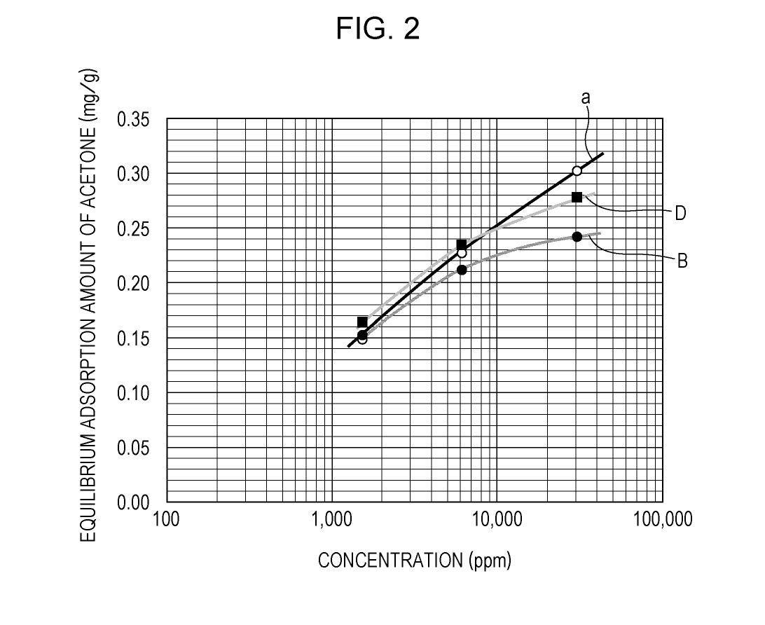

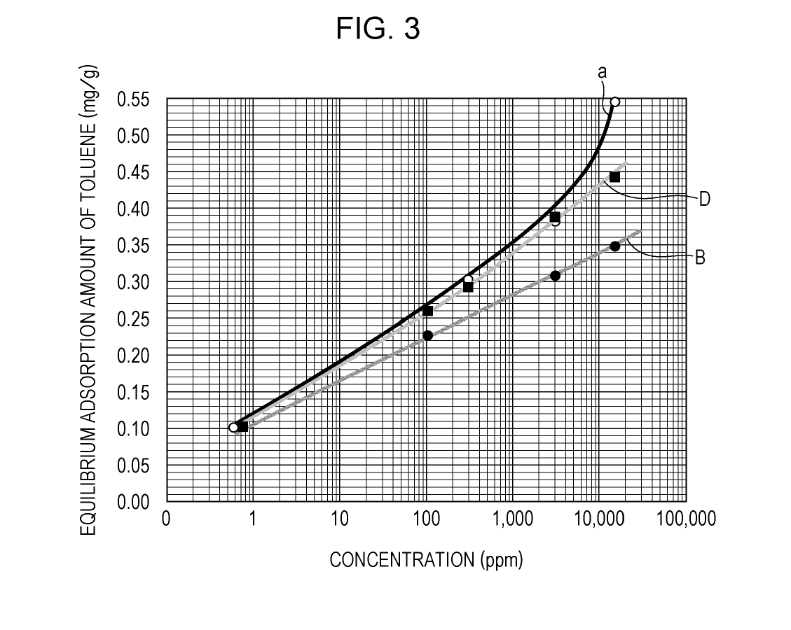

The equilibrium adsorption amount of acetone vapor was measured by the following procedures. That is, the dried sample was added to columns and the mass thereof was measured. Next, each column was fixed to the gas adsorption device in a thermostatic bath. In addition, gas of 3.0 vol % (relative pressure P/P₀=0.10) was ventilated to the gas adsorption device at about 1.0 L/min (900 mL/min and acetone saturated vapor 100 mL/min for dilution) by adjusting acetone vapor flow rate and dry air flow rate to the columns. Subsequently, the columns were taken off after 15 minutes, 30 minutes, and 45 minutes, and the mass thereof was measured, and then the gas was ventilated until the mass of the columns became constant, thereby obtaining an acetone equilibrium adsorption amount in an air atmosphere containing 3 vol % of acetone. Similarly, the acetone equilibrium adsorption amount in an air atmosphere containing 0.6 vol % and 0.15 vol % of acetone using gas of 0.61 vol % (relative pressure P/P₀=0.02) and gas of 0.15 vol % (relative pressure P/P₀=0.005) was calculated. The results are shown in FIG. 2 and listed in Table 4 below. In addition, the curve “a” indicates the data of Example 1 or Example 2, the curve “B” indicates the data of Comparative Example 1B, and the curve “D” indicates the data of Comparative Example 1D in FIG. 2 and FIG. 3 described below.

(Table 4) Acetone equilibrium adsorption amount (unit: acetone milligram/1 gram of sample)

Concentration of acetone (ppm) 1520 6080 30400

### Example 1 150 225 300

### Comparative Example 1B 150 235 240

### Comparative Example 1D 160 210 275

In Example 1, since the adsorbing material is specified by defining the acetone equilibrium adsorption amount in an air atmosphere containing 3 vol % of acetone to 0.29 mg/g or more from the test results of the equilibrium adsorption amount of acetone vapor, it is possible to provide an adsorbing material capable of effectively adsorbing acetone with high efficiency.

### Example 2

Example 2 is a modification of Example 1 and relates to the adsorbing material according to the first to fourth embodiments of the present disclosure and further relates to the adsorbing material according to the sixth embodiment of the present disclosure. That is, the adsorbing material of Example 2 is an adsorbing material which adsorbs toluene and is made of a porous carbon material derived from a plant and in which a toluene equilibrium adsorption amount in an air atmosphere containing 1.5 vol % of toluene is 0.5 mg/g or more. Further, the adsorbing material itself is the same as the adsorbing material of Example 1.

The equilibrium adsorption amount of toluene vapor was measured by the following procedures. That is, 0.20 g of the dried sample of Example 2 having a particle diameter of 0.25 mm to 0.50 mm, 0.20 g of the dried sample of Comparative Example 1B, and 0.20 g of the dried sample of Comparative Example 1D were used. Subsequently, each sample was added to the column with a stainless steel net and the mass thereof was measured. Next, each column was fixed to the gas adsorption device in a thermostatic bath. In addition, gas of 1.50 vol % (relative pressure P/P₀=0.40) was ventilated to the gas adsorption device at about 1.0 L/min by adjusting toluene vapor flow rate and dry air flow rate to the columns. Subsequently, the columns were taken off after 15 minutes, 30 minutes, and 45 minutes, and the mass thereof was measured, and then the gas was ventilated until the mass of the columns became constant, and then the toluene equilibrium adsorption amount in an air atmosphere containing 1.5 vol % of toluene was calculated. Similarly, the toluene equilibrium adsorption amount in an air atmosphere containing 0.37 vol % and 0.01 vol % of toluene using gas of 0.37 vol % (relative pressure P/P₀=0.10) and gas of 0.01 vol % (relative pressure P/P₀=0.0027) was calculated. The results are shown in FIG. 3 and listed in Table 5 below.

(Table 5) Toluene equilibrium adsorption amount (unit: toluene milligram/1 gram of sample)

Concentration of toluene (ppm) 100 3700 15000

Example 2 260 380 550

Comparative Example 1B 225 305 350

Comparative Example 1D 260 385 440

In Example 2, since the adsorbing material is specified by defining the toluene equilibrium adsorption amount in an air atmosphere containing 1.5 vol % of toluene to 0.5 mg/g or more from the test results of the equilibrium adsorption amount of toluene vapor, it is possible to provide an adsorbing material capable of effectively adsorbing toluene with high efficiency.

### Example 3

Example 3 is a modification of Example 1 and relates to the adsorbing material according to the first to fourth embodiments of the present disclosure and further relates to the adsorbing material according to the seventh embodiment of the present disclosure. That is, the adsorbing material of Example 3 is an adsorbing material adsorbing water vapor, which is made of a porous carbon material derived from a plant and in which a water vapor equilibrium adsorption amount in an air atmosphere at a temperature of 40 degrees Celsius in a relative humidity of 84% is 0.50 mg/g or more. Further, the adsorbing material itself is the same as the adsorbing material of Example 1.

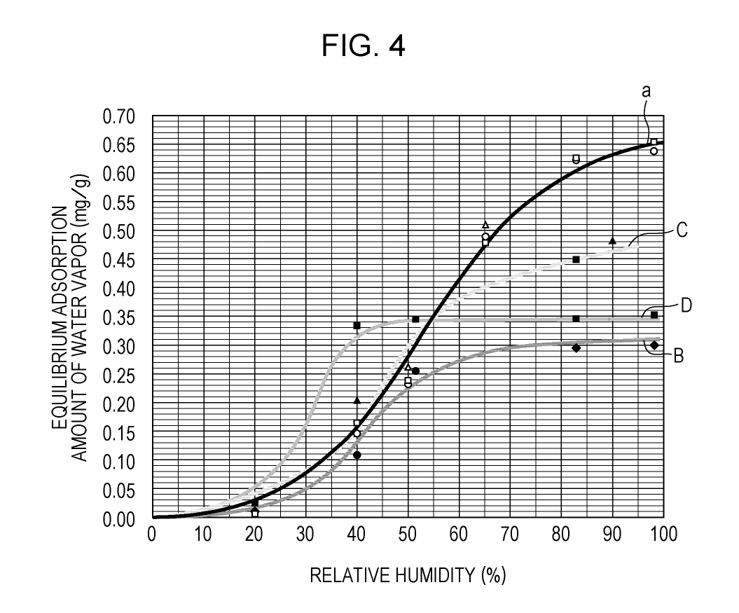

The equilibrium adsorption amount of water vapor was measured by the following procedures. That is, the dried sample was added to the column with a stainless steel net having a volume of 5 ml and the mass thereof was measured. Next, each column was fixed to the gas adsorption device with a cock provided in a thermostatic bath at 40 degrees Celsius. In addition, the water vapor was ventilated to the gas adsorption device by adjusting water vapor flow rate and dry air flow rate to the columns and by changing the flow rate of dry air for dilution and saturated water vapor such that the relative humidity thereof becomes 98%, 84%, 64%, 50%, 40%, or 20%. Subsequently, the vapor was ventilated until the mass of the columns became constant and the equilibrium adsorption amount of water vapor was calculated. The results are shown in FIG. 4 and listed in (Table 6) below. In addition, in FIG. 4, the curve “a” indicates the data of Example 3, the curve “B” indicates the data of Comparative Example 1B, the curve “C” indicates the data of Comparative Example 1C, and the curve “D” indicates the data of Comparative Example 1D.

(Table 6) Water vapor equilibrium adsorption amount (unit: water vapor mg/1 g of sample)

Relative humidity % of water vapor 20 40 50 64 84 98

Example 3 100 140 230 490 620 640

Comparative Example 1B 10 110 250 230 240 250

Comparative Example 1C 40 200 310 370 450 480

Comparative Example 1D 25 330 345 345 345 350

In Example 3, since the adsorbing material is specified by defining the water vapor equilibrium adsorption amount in an air atmosphere at a temperature of 40 degrees Celsius in a relative humidity of 84% to 0.50 mg/g or more from the test results of the equilibrium adsorption amount of water vapor, it is possible to provide an adsorbing material capable of effectively adsorbing water vapor with high efficiency. Further, as a result, it is possible to effectively remove a smell component with the adsorbing material of Example 3 even in a state in which the smell component is attached to water vapor (water molecules) in the air.

### Example 4

Example 4 is a modification of Example 1 and relates to the adsorbing material according to the first to fourth embodiments of the present disclosure and further relates to the adsorbing material according to the eighth embodiment of the present disclosure. That is, the adsorbing material of Example 4 is an adsorbing material adsorbing ammonia, which is made of a porous carbon material derived from a plant and in which when air containing 8 ppm of ammonia gas and having a temperature of 20 degrees Celsius and a relative humidity of 50% is ventilated with a space velocity of 5×10²/hour, a removal rate of accumulated ammonia gas until one hour elapses from the start of ventilation is 0.3 micromol/g or more. In addition, the adsorbing material itself is the same as the adsorbing material of Example 1.

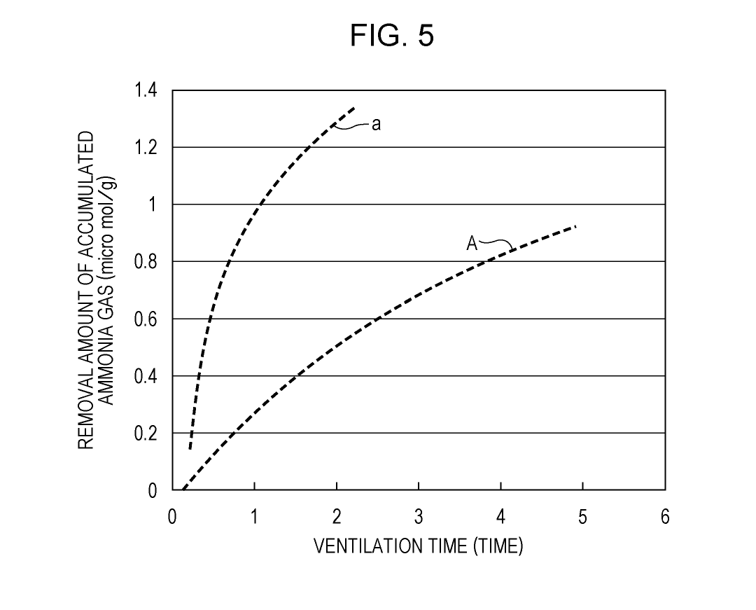

The removal rate of accumulated ammonia gas was measured by the following procedures. That is, the dried sample was added to the column with a stainless steel net (injection cylinder) having a volume of 30 ml and the mass thereof was measured. Next, each column was fixed to the gas adsorption device. In addition, air having a temperature of 20 degrees Celsius and a relative humidity of 50% was flown to the columns with a rate of about 1.0 L/min for about one and a half hours. Subsequently, wet air (temperature of 20 degrees Celsius and a relative humidity of 50%) containing 8 ppm of ammonia gas was flown downward with a rate of 250 mL/min (space velocity 5×10²/hour) to the column. Next, the concentration of the ammonia gas in the inlet and the outlet of the column was calculated by a detector tube for ammonia gas in a desired time interval. Similar test was performed in Comparative Example 1A. The results are shown in FIG. 5. In addition, in FIG. 5, the curve “a” indicates the data of Example 4 and the curve “A” indicates the data of Comparative Example 1A.

In Example 4, when air containing 8 ppm of ammonia gas and having a temperature of 20 degrees Celsius and a relative humidity of 50% is ventilated with a space velocity of 5×10²/hour, since the adsorbing material is specified by defining the removal rate of accumulated ammonia gas until one hour elapses from the start of ventilation to 0.3 micromol/g or more, it is possible to effectively adsorb ammonia with high efficiency.

### Example 5

Example 5 is a modification of Example 1 and relates to the adsorbing material according to the first to fourth embodiments of the present disclosure and further relates to the adsorbing material according to the ninth embodiment of the present disclosure. That is, the adsorbing material of Example 5 is an adsorbing material adsorbing acetaldehyde, which is made of a porous carbon material derived from a plant and in which when air containing 0.14 ppm of acetaldehyde vapor and having a temperature of 20 degrees Celsius and a relative humidity of 50% is ventilated with a space velocity of 1.5×10⁴/hour, a removal rate of accumulated acetaldehyde vapor until one hour elapses from the start of ventilation is 0.2 micromol/g or more. Further, the adsorbing material itself is the same as the adsorbing material of Example 1.

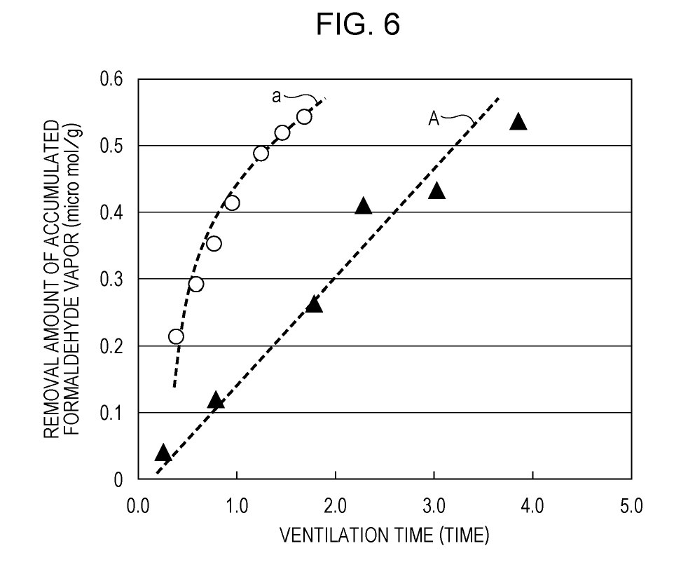

The removal rate of accumulated acetaldehyde vapor was measured by the following procedures. That is, the dried sample was added to columns having a volume of 1 ml and the mass thereof was measured. Next, each column was fixed to the gas adsorption device. In addition, air having a temperature of 20 degrees Celsius and a relative humidity of 50% was flown to the columns until the mass of the columns became constant. Subsequently, wet air (temperature of 20 degrees Celsius and a relative humidity of 50%) containing 0.14 ppm of acetaldehyde vapor was downwardly flown to the columns with a rate of 250 mL/min (space velocity 1.5×10⁴/hour). Next, the concentration of the acetaldehyde vapor in the inlet and the outlet of the column was calculated by a detector tube for acetaldehyde vapor in a desired time interval. A similar test was performed in Comparative Example 1A. The results are shown in FIG. 6. In addition, in FIG. 6, the curve “a” indicates the data of Example 5 and the curve “A” indicates the data of Comparative Example 1A.

In Example 5, when air containing 0.14 ppm of acetaldehyde vapor and having a temperature of 20 degrees Celsius and a relative humidity of 50% is ventilated with a space velocity of 1.5×10⁴/hour, since the adsorbing material is specified by defining the removal rate of accumulated acetaldehyde vapor until one hour elapses from the start of ventilation to 0.2 micromol/g or more, it is possible to effectively adsorb acetaldehyde with high efficiency.

Hereinbefore, the present disclosure is described with reference to the preferred Examples, but the present disclosure is not limited thereto and various modifications are possible. In Examples, the case where the chaff was used as the raw material of the porous carbon material is described, but other plants may be used as a raw material. Here, examples of other plants may include straw, reeds, wakame seaweed stems, tracheophytes growing on the ground, ferns, bryophytes, algae, and seaweeds. In addition, these materials may be used alone or plural kinds thereof may be used as a mixture. Specifically, for example, rice straw (product of Kagoshima: Isehikari) is used as a material derived from a plant as a raw material of a porous carbon material, and the porous carbon material is converted to a carbonaceous material (porous carbon material precursor) by carbonizing the straw as a raw material, which can be achieved by applying an acid treatment. Alternatively, reeds of rice are used as a material derived from a plant as a raw material of the porous carbon material and the porous carbon material is converted to a carbonaceous material (porous carbon material precursor) by carbonizing the reeds of rice as a raw material, which can be achieved by applying an acid treatment. In addition, even in the porous carbon material obtained by being treated in alkali (base) such as an aqueous solution of sodium hydroxide instead of an aqueous solution of hydrofluoric acid, the same results were obtained.

Alternatively, wakame stems (product of Sanriku of Iwate-ken) are used as a material derived from a plant as a raw material of a porous carbon material and the porous carbon material is converted to a carbonaceous material (porous carbon material precursor) by carbonizing the wakame stems as a raw material and can be achieved by applying an acid treatment. Specifically, for example, the wakame stems are heated with a temperature of about 500 degrees Celsius to be carbonized. In addition, the wakame stems as a raw material may be treated with alcohol before heating. As a specific treatment method, a method for immersing a material in ethyl alcohol or the like, and by doing this, it is possible to reduce the moisture contained in a raw material and elute mineral components or other elements other than carbon contained in the finally obtained porous carbon material. Further, it is possible to prevent gas from being generated during the carbonization by treating with alcohol. More specifically, the wakame stems are immersed in ethyl alcohol for 48 hours. Moreover, it is preferable that an ultrasonication treatment be performed in ethyl alcohol. Next, the wakame stems are carbonized by being heated in a nitrogen gas stream at 500 degrees Celsius for 5 hours, thereby obtaining carbides. Further, it is possible to reduce or remove a tar component to be generated during the next carbonization by applying such a preliminary carbonization treatment. Subsequently, 10 g of the carbides were put into an alumina crucible, the temperature therein was raised up to 1000 degrees Celsius with a temperature raising rate of 5 degree/min in a nitrogen gas stream (10 L/min), and carbonization was carried out at 1000 degrees Celsius for 5 hours, and the resultant was converted to a carbonaceous material (porous carbon material precursor) to be cooled to room temperature. In addition, the nitrogen gas was continuously flown during the carbonization and the cooling. Subsequently, the acid treatment was carried out by immersing the porous carbon material precursor in an aqueous solution of hydrofluoric acid of 46 vol/% for one night, and then the resultant was washed with water and ethyl alcohol until the pH thereof became 7 and then was dried, thereby obtaining a porous carbon material.

Further, the present disclosure may have the following configurations.

(A01) (Adsorbing material: first embodiment)

An adsorbing material for a filter for air purification, which is made of a porous carbon material derived from a plant and in which a value of particle porosity epsilonₚis 0.7 or more.

(A02) The adsorbing material for a filter for air purification according to (A01), in
which particle apparent density rhoₚ is 0.5 g/mL or less.
(A03) The adsorbing material for a filter for air purification according to (A01) or
(A02), in which the particle porosity epsilonₚ is defined as follows:

particle porosity epsilonₚ=alpha*beta*rhoₚ,

here,
rhoₚ is particle apparent density (unit: gram/milliliter) and calculated by 1/(1/rhoₜ+alpha*beta).
rhoₜ is particle true density (unit: gram/milliliter) and calculated by (sample mass/sample volume).
alpha is water content (g-water/g-wet) per wet weight,
beta is a conversion factor of dry weight (g-wet/g-dry).
(A04) The adsorbing material for a filter for air purification according to any one of (A01) to (A03), which adsorbs acetone.
(A05) The adsorbing material for a filter for air purification according to any one of (A01) to (A03), which adsorbs toluene.
(A06) The adsorbing material for a filter for air purification according to any one of (A01) to (A03), which adsorbs ammonia.
(A07) The adsorbing material for a filter for air purification according to any one of (A01) to (A03), which adsorbs acetaldehyde.
(A08) The adsorbing material for a filter for air purification according to any one of (A01) to (A03), which adsorbs water vapor.
(B01) (Adsorbing material: second embodiment)
An adsorbing material for a filter for air purification, which is made of a granular porous carbon material derived from a plant, in which a value of filling density rho_{b} is 0.2 g/mL or less.
(B02) The adsorbing material for a filter for air purification according to (B01), in which the filling density rho_{b} is calculated by obtaining the volume of 5.00 g of a dry porous carbon material having a particle diameter of 0.25 mm to 0.50 mm and by dividing the mass value of the dry porous carbon material by the volume value thereof.
(B03) The adsorbing material for a filter for air purification according to (B01) or (B02), in which an aspect ratio of the granular porous carbon material is 20 or less.
(B04) The adsorbing material for a filter for air purification according to any one of (B01) to (B03), which adsorbs acetone.
(B05) The adsorbing material for a filter for air purification according to any one of (B01) to (B03), which adsorbs toluene.
(B06) The adsorbing material for a filter for air purification according to any one of (B01) to (B03), which adsorbs ammonia.
(B07) The adsorbing material for a filter for air purification according to any one of (B01) to (B03), which adsorbs acetaldehyde.
(B08) The adsorbing material for a filter for air purification according to any one of (B01) to (B03), which adsorbs water vapor.
(C01) (Adsorbing material: third embodiment)
An adsorbing material for a filter for air purification, which is made of a porous carbon material derived from a plant and in which a volume of a fine pore having a diameter of 20 nm or more is 1.0 mL/g or more based on a water vapor adsorption method.
(C02) The adsorbing material for a filter for air purification according to (C01), which adsorbs acetone.
(C03) The adsorbing material for a filter for air purification according to (C01), which adsorbs toluene.
(C04) The adsorbing material for a filter for air purification according to (C01), which adsorbs ammonia.
(C05) The adsorbing material for a filter for air purification according to (C01), which adsorbs acetaldehyde.
(C06) The adsorbing material for a filter for air purification according to (C01), which adsorbs water vapor.
(D01) (Adsorbing material: fourth material)
An adsorbing material for a filter for air purification, which is made of a porous carbon material derived from a plant and in which a volume of a fine pore having a diameter of 1 nm or more is 0.6 mL/g or more based on a methanol method.
(D02) The adsorbing material for a filter for air purification according to (D01), which adsorbs acetone.
(D03) The adsorbing material for a filter for air purification according to (D01), which adsorbs toluene.
(D04) The adsorbing material for a filter for air purification according to (D01), which adsorbs ammonia.
(D05) The adsorbing material for a filter for air purification according to (D01), which adsorbs acetaldehyde.
(D06) The adsorbing material for a filter for air purification according to (D01), which adsorbs water vapor.
(E01) (Adsorbing material: fifth embodiment)
An adsorbing material adsorbing acetone, which is made of a porous carbon material derived from a plant and in which an equilibrium adsorption amount of acetone in an air atmosphere containing 3 vol % of acetone is 0.29 mg/g or more.
(F01) (Adsorbing material: sixth embodiment)
An adsorbing material adsorbing toluene, which is made of a porous carbon material derived from a plant and in which an equilibrium adsorption amount of toluene in an air atmosphere containing 1.5 vol % of toluene is 0.5 mg/g or more.
(G01) (Adsorbing material: seventh embodiment)
An adsorbing material adsorbing water vapor, which is made of a porous carbon material derived from a plant and in which an equilibrium adsorption amount of water vapor in an air atmosphere having a temperature of 40 degrees Celsius and a relative humidity of 84% is 0.50 mg/g or more.
(H01) (Adsorbing material: eighth embodiment)
An adsorbing material adsorbing ammonia, which is made of a porous carbon material derived from a plant and in which when air containing 8 ppm of ammonia gas and having a temperature of 20 degrees Celsius and a relative humidity of 50% is ventilated with a space velocity of 5×10²/hour, a removal rate of accumulated ammonia gas until one hour elapses from the start of ventilation is 0.3 micromol/g or more.
(J01) (Adsorbing material: ninth embodiment)
An adsorbing material adsorbing acetaldehyde, which is made of a porous carbon material derived from a plant and in which when air containing 0.14 ppm of acetaldehyde vapor and having a temperature of 20 degrees Celsius and a relative humidity of 50% is ventilated with a space velocity of 1.5×10⁴/hour, a removal rate of accumulated acetaldehyde vapor until one hour elapses from the start of ventilation is 0.2 micromol/g or more.

### Additional Embodiments

(K) An adsorbing material comprising: a porous carbon material derived from a raw material including a plant derived material, wherein the porous carbon material comprises a plurality of fine pores, and wherein the porous carbon material comprises at least one of a particle apparent density (rhoₚ) of 0.5 g/mL or less, and a particle porosity (epsilonₚ) of 0.7 or more.
(K01) The adsorbing material of (K), wherein the porous carbon material includes a first pore volume having a first diameter greater than 20 nm, wherein the porous carbon material includes a second pore volume having a second diameter less than 20 nm, and wherein the first pore volume is greater in number than the second pore volume.
(K02) The adsorbing material of (K), wherein a fine pore volume of at least one of the fine pores is 0.1 cm³/g or more.
(K03) The adsorbing material of (K), wherein the porous carbon material has a particle true density (rhoₜ) of 1.99 g/mL.
(K04) The adsorbing material of (K), wherein the fine pores include a mesofine pore having a mesofine pore diameter ranging from 2 nm to 50 nm, and at least one of a macrofine pore having a macrofine pore diameter of more than 50 nm and a mircofine pore having a mircofine pore diameter of less than 2 nm.
(K05) The adsorbing material of (K), wherein the adsorbing material is granular with an aspect ratio of 20 or less.
(K06) The adsorbing material of (K), wherein the porous carbon material has a filling porosity (epsilon_{b}) of 0.6.
(K07) The adsorbing material of (K), wherein the porous carbon material has a filling density (rho_{b}) of 0.2 g/mL or less.
(K08) The adsorbing material of (K), wherein the plant derived material is selected from the group consisting of chaff, rice chaff, barley, wheat, rye, barnyard millet, millet, straw, coffee beans, tea leaves, sugarcanes, mealies, fruit skins, a reed, and a wakame seaweed stem.
(K09) The adsorbing material of (K), wherein the porous carbon material is capable of adsorbing at least one of acetone, toluene, water vapor, ammonia, and acetaldehyde.
(K10) The adsorbing material of (K), wherein the porous carbon material has a surface that is treated by any one of a chemical treatment and a molecular modification.
(K11) The adsorbing material of (K), further comprising a polymer wherein the porous carbon material and the polymer form a complex material.
(K12) The adsorbing material of (K), further comprising a supporting member configured to support the porous carbon material.
(L) A filter comprising an adsorbing material, the adsorbing material comprising a porous carbon material derived from a raw material including a plant derived material, wherein the porous carbon material comprises a plurality of fine pores, and wherein the porous carbon material comprises at least one of a particle apparent density (rhoₚ) of 0.5 g/mL or less, and a particle porosity (epsilonₚ) of 0.7 or more.
(L01) The filter of (L), wherein the porous carbon material includes a first pore volume having a first diameter greater than 20 nm, wherein the porous carbon material includes a second pore volume having a second diameter less than 20 nm, and wherein the first pore volume is greater in number than the second pore volume.
(L02) The filter of (L), wherein the fine pores include a mesofine pore having a mesofine pore diameter ranging from 2 nm to 50 nm.
(L03) The filter of (L), wherein the porous carbon material has a filling density (rho_{b}) of 0.2 g/mL or less.
(L04) The filter of (L), wherein the plant derived material is selected from the group consisting of chaff, rice chaff, barley, wheat, rye, barnyard millet, millet, straw, coffee beans, tea leaves, sugarcanes, mealies, fruit skins, a reed, and a wakame seaweed stem.
(L05) The filter of (L), wherein the porous carbon material is capable of adsorbing at least one of acetone, toluene, water vapor, ammonia, and acetaldehyde.
(L06) The filter of (L), wherein the porous carbon material has a surface that is treated by any one of a chemical treatment and a molecular modification.
(L07) The filter of (L), further comprising a polymer wherein the porous carbon material and the polymer form a complex material.
(L08) The filter of (L), further comprising a supporting member configured to support the porous carbon material.

It should be understood by those skilled in the art that various modifications, combinations, sub-combinations and alterations may occur depending on design requirements and other factors insofar as they are within the scope of the appended claims or the equivalents thereof.

1. An adsorbing material comprising: a porous carbon material derived from a raw material including a plant derived material, wherein the porous carbon material comprises a plurality of fine pores, and wherein the porous carbon material comprises at least one of a particle apparent density (rhoₚ) of 0.5 g/mL or less, and a particle porosity (epsilonₚ) of 0.7 or more.

2. The adsorbing material of claim 1, wherein the porous carbon material includes a first pore volume having a first diameter greater than 20 nm, wherein the porous carbon material includes a second pore volume having a second diameter less than 20 nm, and wherein the first pore volume is greater in number than the second pore volume.

3. The adsorbing material of claim 1, wherein a fine pore volume of at least one of the fine pores is 0.1 cm³/g or more.

4. The adsorbing material of claim 1, wherein the porous carbon material has a particle true density (rhoₜ) of 1.99 g/mL.

5. The adsorbing material of claim 1, wherein the fine pores include a mesofine pore having a mesofine pore diameter ranging from 2 nm to 50 nm, and at least one of a macrofine pore having a macrofine pore diameter of more than 50 nm and a mircofine pore having a mircofine pore diameter of less than 2 nm.

6. The adsorbing material of claim 1, wherein the adsorbing material is granular with an aspect ratio of 20 or less.

7. The adsorbing material of claim 1, wherein the porous carbon material has a filling porosity (epsilon_{b}) of 0.6.

8. The adsorbing material of claim 1, wherein the porous carbon material has a filling density (rho_{b}) of 0.2 g/mL or less.

9. The adsorbing material of claim 1, wherein the plant derived material is selected from the group consisting of chaff, rice chaff, barley, wheat, rye, barnyard millet, millet, straw, coffee beans, tea leaves, sugarcanes, mealies, fruit skins, a reed, and a wakame seaweed stem.

10. The adsorbing material of claim 1, wherein the porous carbon material is capable of adsorbing at least one of acetone, toluene, water vapor, ammonia, and acetaldehyde.

11. The adsorbing material of claim 1, wherein the porous carbon material has a surface that is treated by any one of a chemical treatment and a molecular modification.

12. The adsorbing material of claim 1, further comprising a polymer wherein the porous carbon material and the polymer form a complex material.

13. The adsorbing material of claim 1, further comprising a supporting member configured to support the porous carbon material.

14. A filter comprising an adsorbing material, the adsorbing material comprising a porous carbon material derived from a raw material including a plant derived material, wherein the porous carbon material comprises a plurality of fine pores, and wherein the porous carbon material comprises at least one of a particle apparent density (rhoₚ) of 0.5 g/mL or less, and a particle porosity (epsilonₚ) of 0.7 or more.

15. The filter of claim 14, wherein the porous carbon material includes a first pore volume having a first diameter greater than 20 nm, wherein the porous carbon material includes a second pore volume having a second diameter less than 20 nm, and wherein the first pore volume is greater in number than the second pore volume.

16. The filter of claim 14, wherein the fine pores include a mesofine pore having a mesofine pore diameter ranging from 2 nm to 50 nm.

17. The filter of claim 14, wherein the porous carbon material has a filling density (rho_{b}) of 0.2 g/mL or less.

18. The filter of claim 14, wherein the plant derived material is selected from the group consisting of chaff, rice chaff, barley, wheat, rye, barnyard millet, millet, straw, coffee beans, tea leaves, sugarcanes, mealies, fruit skins, a reed, and a wakame seaweed stem.

19. The filter of claim 14, wherein the porous carbon material is capable of adsorbing at least one of acetone, toluene, water vapor, ammonia, and acetaldehyde.

20. The filter of claim 14, wherein the porous carbon material has a surface that is treated by any one of a chemical treatment and a molecular modification.

21. The filter of claim 14, further comprising a polymer wherein the porous carbon material and the polymer form a complex material.

22. The filter of claim 14, further comprising a supporting member configured to support the porous carbon material.
